(19) United States
(12) Patent Application Publication
(10) Pub. No.: US 2020/0319308 A1
(43) Pub. Date: Oct. 8, 2020

(54) DETECTING EQUIPMENT AND MOVEABLE PLATFORM

(71) Applicant: SZ DJI TECHNOLOGY CO., LTD., Shenzhen (CN)

(72) Inventors: Jiebin XIE, Shenzhen (CN); Wei REN, Shenzhen (CN)

(21) Appl. No.: 16/872,751

(22) Filed: May 12, 2020

Related U.S. Application Data
(63) Continuation of application No. PCT/CN2017/113659, filed on Nov. 29, 2017.

(51) Int. Cl. G01S 7/481; G01S 17/10; G01S 17/36; G01S 7/48

(52) U.S. Cl. CPC G01S 7/4813; G01S 7/4802; G01S 17/36; G01S 17/10

(57) ABSTRACT

A detecting equipment and a movable platform are provided. The detecting equipment includes a light-emitting component, a photosensitive component, a processing component, a first optical element, a second optical element, and a circuit board. The circuit board contains a first through-hole and a second through-hole. A light signal emitted by the light-emitting component is configured to successively pass through the first through-hole and the first optical element, and a light signal reflected by a target object is configured to successively pass through the second optical element and the second through-hole to reach the photosensitive component. According to the light signal emitted by the light-emitting component and the light signal received by the photosensitive component and reflected by the target object, the processing component is configured to determine information associated with the target object.

### CROSS-REFERENCE TO RELATED APPLICATION

This application is a continuation of International Application No. PCT/CN2017/113659, filed on Nov. 29, 2017, the entirety of which is incorporated herein by reference.

### TECHNICAL FIELD

The present disclosure generally relates to the field of testing technology and, more particularly, relates to a detecting equipment and a movable platform.

BACKGROUND

A movable platform, e.g., an unmanned aerial vehicle, a movable robot, etc., often needs to be installed with a detecting equipment. The detecting equipment is configured to detect a target object (e.g., an obstacle, a tracking object, etc.) around the movable platform.

The detecting equipment mainly includes a light-emitting component, a photosensitive component, and a processing component, etc. To improve the detecting performance of the detecting equipment, the detecting equipment often further includes an optical element, e.g., a lens, to improve light utilization efficiency. The installation position relationship of each component in an existing detecting equipment causes a substantially large volume of the detecting equipment and does not facilitate miniaturization. The disclosed detecting equipment and movable platform are directed to solve one or more problems set forth above and other problems.

### SUMMARY

One aspect of the present disclosure provides a detecting equipment. The detecting equipment includes a light-emitting component, a photosensitive component, a processing component, a first optical element, a second optical element, and a circuit board. The light-emitting component, the photosensitive component, and the processing component are configured on the circuit board, and the light-emitting component and the photosensitive component are electrically connected to the processing component, respectively. The light-emitting component and the photosensitive component are configured on a first plane of the circuit board, and the first optical element and the second optical element are configured on a second plane of the circuit board. The circuit board contains a first through-hole and a second through-hole. A light signal emitted by the light-emitting component is configured to successively pass through the first through-hole and the first optical element, and a light signal reflected by a target object is configured to successively pass through the second optical element and the second through-hole to reach the photosensitive component. According to the light signal emitted by the light-emitting component and the light signal received by the photosensitive component and reflected by the target object, the processing component is configured to determine information associated with the target object.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic structural diagram of an exemplary detecting equipment consistent with disclosed embodiments of the present disclosure;

FIG. 2 illustrates a cross-sectional view of an exemplary detecting equipment consistent with disclosed embodiments of the present disclosure;

FIG. 3 illustrates a cross-sectional view of another exemplary detecting equipment consistent with disclosed embodiments of the present disclosure;

FIG. 4 illustrates a cross-sectional view of another exemplary detecting equipment consistent with disclosed embodiments of the present disclosure;

FIG. 5 illustrates a top view of an exemplary detecting equipment consistent with disclosed embodiments of the present disclosure;

FIG. 6 illustrates a top view of another exemplary detecting equipment consistent with disclosed embodiments of the present disclosure;

FIG. 7 illustrates a cross-sectional view of another exemplary detecting equipment consistent with disclosed embodiments of the present disclosure;

FIG. 8 illustrates a cross-sectional view of another exemplary detecting equipment consistent with disclosed embodiments of the present disclosure;

FIG. 9 illustrates a schematic structural diagram of another exemplary detecting equipment consistent with disclosed embodiments of the present disclosure;

FIG. 10 illustrates a schematic structural diagram of another exemplary detecting equipment consistent with disclosed embodiments of the present disclosure;

FIG. 11 illustrates a schematic structural diagram of another exemplary detecting equipment consistent with disclosed embodiments of the present disclosure;

FIG. 12 illustrates a schematic structural diagram of another exemplary detecting equipment consistent with disclosed embodiments of the present disclosure;

FIG. 13 illustrates a schematic structural diagram of another exemplary detecting equipment consistent with disclosed embodiments of the present disclosure;

FIG. 14 illustrates a schematic structural diagram of another exemplary detecting equipment consistent with disclosed embodiments of the present disclosure;

FIG. 15 illustrates a schematic structural diagram of another exemplary detecting equipment consistent with disclosed embodiments of the present disclosure;

FIG. 16 illustrates a schematic structural diagram of another exemplary detecting equipment consistent with disclosed embodiments of the present disclosure;

FIG. 17 illustrates a schematic structural diagram of another exemplary detecting equipment consistent with disclosed embodiments of the present disclosure; and

FIG. 18 illustrates a schematic structural diagram of an exemplary unmanned aerial vehicle consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

When a component is called to be “fixed to” another component, the component may be directly on the another component, or a component may be therebetween. When a component is considered to be “connected” to another component, the component may be directly connected to the another component, or a component may be therebetween. The term “and/or” as used herein may include one or more of any and all combinations of the associated listed items. In the case of no conflict, the following embodiments and features can be combined with each other.

A movable platform, e.g., an unmanned aerial vehicle, a movable robot, etc., may often need to be installed with a detecting equipment. The detecting equipment may be configured to detect a target object around the movable platform. The detecting equipment may include any detecting equipment that measures information associated with the target object by emitting a light signal and receiving a light signal reflected by the target object. In one embodiment, the detecting equipment may be a time of flight (TOF) detecting equipment, a laser detecting equipment, etc.

Taking the TOF detecting equipment as an example, the TOF detecting equipment may often include a light-emitting component, a photosensitive component, and a processing component, etc. The light-emitting component may be configured to emit a light signal. The photosensitive component may be configured to receive a light signal reflected by the target object. According to the light signal emitted by the light-emitting component and the light signal reflected by the target object and received by the photosensitive component, the processing component may be configured to determine information, e.g., a distance between the target object such as an obstacle and the TOF detecting equipment, and the position and moving speed of the target object with respect to the TOF detecting equipment, etc.

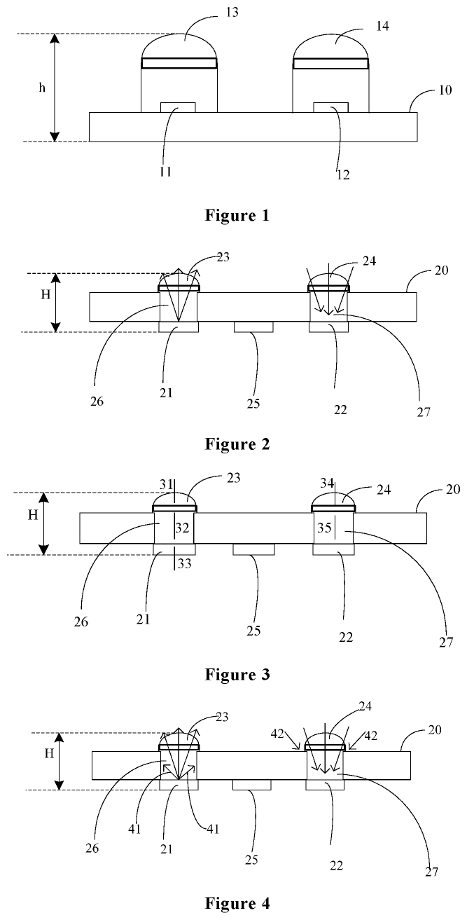

To improve the detecting performance of the TOF detecting equipment, the TOF detecting equipment may further include an optical element, e.g., a lens, to improve light utilization efficiency. Referring to FIG. 1, the TOF detecting equipment may include a circuit board 10, e.g., a printed circuit board (PCB); a light-emitting component 11, e.g., a light-emitting diode (LED), a laser diode (LD), etc., disposed on the circuit board 10; a photosensitive component 12, e.g., a photo diode (PD), a single photon avalanche diode (SPAD), etc., disposed on the circuit board 10; an optical element 13, e.g., a lens, corresponding to the light-emitting component 11; and an optical element 14, e.g., a lens, corresponding to the photosensitive component 12. For illustrative purposes, the optical element 13 may have a size consistent with the optical element 14. A thickness h of the TOF detecting equipment may refer to a sum of a distance between the optical element 13 and the light-emitting component 11 and a thickness of the circuit board 10.

Referring to FIG. 1, the optical element 13 and the light-emitting component 11, as well as the photosensitive component 12 and the optical element 14 may be disposed on a same side of the circuit board, which may cause a protruding distance of the optical element 13 and the optical element 14 to be substantially large, and may increase the volume of the detecting equipment. In addition, in general, the larger the aperture of the lens, the higher the light utilization efficiency, and the better the detecting performance of the TOF detecting equipment. To increase the aperture of the lens, the size of the lens may need to be enlarged. The components arrangement relationship as illustrated in FIG. 1 may further increase the thickness of the TOF detecting equipment, which may cause the TOF detecting equipment to occupy a substantially large space on the movable platform.

The present disclosure provides a detecting equipment. FIG. 2 illustrates a cross-sectional view of a detecting equipment consistent with disclosed embodiments of the present disclosure. Referring to FIG. 2, the detecting equipment may include a circuit board 20, a light-emitting component 21, a photosensitive component 22, a first optical element 23, a second optical element 24, and a processing component 25. The light-emitting component 21, the photosensitive component 22, and the processing component 25 may be disposed on the circuit board 20. The light-emitting component 21 and the photosensitive component 22 may be electrically connected to the processing component 25, respectively. The light-emitting component 21 and the photosensitive component 22 may be disposed on a first plane of the circuit board 20. The first optical element 23 and the second optical element 24 may be disposed on a second plane of the circuit board 20.

The circuit board 20 may contain a first through-hole 26 and a second through-hole 27. The light signal emitted by the light-emitting component 21 may successively pass through the first through-hole 26 and the first optical element 23. The light signal reflected by the target object may successively pass through the second optical element 24 and the second through-hole 27 to reach the photosensitive component 22. The processing component 25 may be configured to determine information associated with the target object according to the light signal emitted by the light-emitting component 21 and the light signal reflected by the target object and received by the photosensitive component 22.

Referring to FIG. 1, when the optical element 13 has a size consistent with the optical element 14, the thickness h of the detecting equipment may refer to a sum of the distance between the optical element 13 and the light-emitting component 11 and the thickness of the circuit board 10. Referring to FIG. 2, when the first optical element 23 has a size consistent with the second optical element 24, a thickness H of the detecting equipment may refer to a distance between the first optical element 23 and the light-emitting component 21. The distance between the first optical element 23 and the light-emitting component 21 may already include the thickness of the circuit board, which may fully utilize the thickness of the circuit board itself. Therefore, H may be smaller than h. In general, H may be 1 mm-3 mm smaller than h.

In one embodiment, the processing component 25 may determine information associated with the target object according to the light signal emitted by the light-emitting component 21 and the light signal reflected by the target object and received by the photosensitive component 22. The implementation method may include following.

In one embodiment, the processing component may be configured to determine the information associated with the target object according to the time when the light-emitting component emits the light signal and the time when the photosensitive component receives the light signal reflected by the target object. In one embodiment, the information associated with the target object may include at least one of a distance between the target object and the detecting equipment, position information of the target object with respect to the detecting equipment, or speed information of the target object with respect to the detecting equipment.

In one embodiment, the detecting equipment may be a TOF detecting equipment. The time when the light-emitting component 21 emits the light signal may be denoted as t1. The light signal emitted by the light-emitting component 21 may pass through the first through-hole 26 and the first optical element 23. When a target object, e.g., an obstacle, is around the TOF detecting equipment, the target object may receive the light signal emitted by the light-emitting component 21, and may reflect the light signal. The light signal reflected by the target object may pass through the second optical element 24 and the second through-hole 27, and may be received by the photosensitive component 22. The time when the photosensitive component 22 receives the light signal reflected by the target object may be denoted as t2. The processing component 25 may determine the distance between the target object and the TOF detecting equipment according to the time difference between t1 and t2, and the speed of light. In addition, in certain embodiments, the processing component 25 may determine the position information or the speed information of the target object with respect to the TOF detecting equipment according to t1 and t2.

In another embodiment, the processing component may be configured to determine the information associated with the target object according to a phase of the light signal emitted by the light-emitting component and a phase of the light signal reflected by the target object and received by the photosensitive component. In one embodiment, the information associated with the target object may include at least one of a distance between the target object and the detecting equipment, position information of the target object with respect to the detecting equipment, or speed information of the target object with respect to the detecting equipment.

In one embodiment, the phase of the light signal emitted by the light-emitting component may be denoted as P1. The light signal emitted by the light-emitting component 21 may pass through the first through-hole 26 and the first optical element 23. When a target object, e.g., an obstacle, is around the detecting equipment, the target object may receive the light signal emitted by the light-emitting component 21, and may reflect the light signal. The light signal reflected by the target object may pass through the second optical element 24 and the second through-hole 27, and may be received by the photosensitive component 22. The phase of the light signal reflected by the target object and received by the photosensitive component may be denoted as P2. The processing component 25 may determine the distance between the target object and the detecting equipment according to the phase difference between P1 and P2. In addition, in certain embodiments, the processing component 25 may determine the position information or the speed information of the target object with respect to the detecting equipment according to P1 and P2.

In one embodiment, the processing component 25 may be a general-purpose processor, e.g., a central processing unit (CPU), or any other suitable processor capable of calling a program. In another embodiment, the processing component 25 may be one or more integrated circuits, e.g., one or more application specific integrated circuits (ASIC), one or more digital signal processors (DSP), or one or more on-site field programmable gate arrays (FPGA), etc. These integrated circuits may be integrated together to form a chip. In certain embodiments, the processing component 25 may be an application specific processor adapted to the light-emitting component 21 and the photosensitive component 22.

In addition, the processing component 25 may not only determine the information associated with the target object, but also have at least one of following functions: powering the light-emitting component 21, powering the photosensitive component 22, or controlling the light-emitting component 21, e.g., controlling the intensity, frequency, etc., of the light signal emitted by the light-emitting component 21.

Referring to FIG. 2, the light-emitting component 21 and the photosensitive component 22 may be disposed on the back of the circuit board 20. The first optical element 23 and the second optical element 24 may be disposed on the front of the circuit board 20. In another embodiment, the light-emitting component 21 and the photosensitive component 22 may be disposed on the front of the circuit board 20. The first optical element 23 and the second optical element 24 may be disposed on the back of the circuit board 20.

In one embodiment, the light-emitting component 21 may include at least one of a light-emitting diode (LED), or a laser diode (LD). The photosensitive component 22 may include at least one of a photodiode (PD), or a single photon avalanche diode (SPAD). The first optical element 23 may include at least one of a plano-convex lens, a biconvex lens, or a combination of lenses. The second optical element 24 may include at least one of a plano-convex lens, a biconvex lens, or a combination of lenses.

In one embodiment, the light-emitting component 21 and the photosensitive component 22 may be attached to a first plane of the circuit board 20. The first optical element 23 and the second optical element 24 may be attached to a second plane of the circuit board 20. The processing component 25 may be attached to the first plane of the circuit board 20. In one embodiment, the circuit board 20 may be a PCB, and the light-emitting component 21, the photosensitive component 22, and the processing component 25 may be attached to the back of the PCB.

Referring to FIG. 3, the first optical element 23 may have an optical axis 31, the first through-hole 26 may have an axis 32, and the light-emitting component 21 may have an optical axis 33. The second optical element 24 may have an optical axis 34, and the second through-hole 27 may have an axis 35.

In one embodiment, the optical axis 33 of the light-emitting component 21, the axis 32 of the first through-hole 26, and the optical axis 31 of the first optical element 23 may substantially overlap with each other. The optical axis 34 of the second optical element 24 and the axis 35 of the second through-hole 27 may substantially overlap with each other.

In addition, in certain embodiments, the detecting equipment may merely contain the first optical element 23. Alternatively, the detecting equipment may merely contain the second optical element 24. Alternatively, the detecting equipment may simultaneous contain the first optical element 23 and the second optical element 24.

In the disclosed detecting equipment, the light-emitting component and the photosensitive component may be disposed on the first plane of the circuit board. The first optical element corresponding to the light-emitting component and the second optical element corresponding to the photosensitive component may be disposed on the second plane of the circuit board. The circuit board may contain the first through-hole and the second through-hole. Therefore, the light signal emitted by the light-emitting component may successively pass through the first through-hole and the first optical element, and the light signal reflected by the target object may successively pass through the second optical element and the second through-hole to reach the photosensitive component. When the first optical element has a size consistent with the second optical element, the thickness of the detecting equipment may be the distance between the first optical element and the light-emitting component. The distance between the first optical element and the light-emitting component may already include the thickness of the circuit board itself, which may fully utilize the thickness of the circuit board itself to reduce the thickness of the detecting equipment, thereby saving the installation space of the detecting equipment on the movable platform.

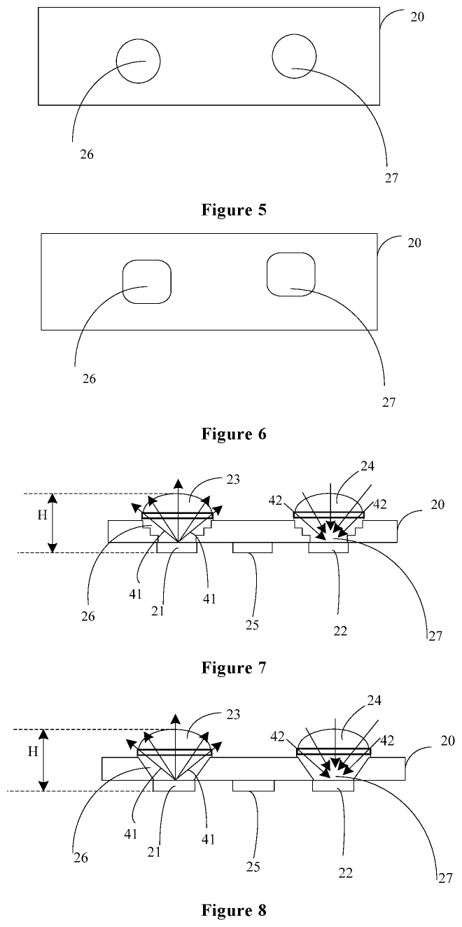

The present disclosure provides a detecting equipment. FIG. 4 illustrates a cross-sectional view of another detecting equipment consistent with disclosed embodiments of the present disclosure, FIG. 5 illustrates a top view of a detecting equipment consistent with disclosed embodiments of the present disclosure, and FIG. 6 illustrates a top view of another detecting equipment consistent with disclosed embodiments of the present disclosure.

On the basis of the above-disclosed embodiments, in one embodiment, the first through-hole 26 and/or the second through-hole 27 may be a cylindrical through-hole or a rounded rectangular through-hole.

FIG. 5 illustrates a top view of the detecting equipment illustrated in FIG. 4. When the first through-hole 26 and/or the second through-hole 27 in FIG. 4 is a cylindrical through-hole, in the top view illustrated in FIG. 5, a cross-section of the first through-hole 26 and/or the second through-hole 27 may have a circular shape.

FIG. 6 illustrates a top view of the detecting equipment illustrated in FIG. 4. When the first through-hole 26 and/or the second through-hole 27 in FIG. 4 is a rounded rectangular through-hole, in the top view illustrated in FIG. 6, a cross-section of the first through-hole 26 and/or the second through-hole 27 may have a rounded rectangular shape.

Referring to FIG. 4, a light signal indicated by 41 among the light signal emitted by the light-emitting component 21 may be easily blocked by the hole-wall of the first through-hole 26 and may not pass through the first through-hole 26 and the first optical element 23. Similarly, for the second optical element 24, a light signal indicated by 42 among the light signal reflected by the target object may be easily blocked by the detecting equipment and may not pass through the second through-hole 27 to reach the photosensitive component 22.

In certain embodiments, the first through-hole 26 and/or the second through-hole 27 may be improved. The diameter of the first through-hole may gradually decrease along a direction approaching the light-emitting component, and/or the diameter of the second through-hole may gradually decrease along a direction approaching the photosensitive component.

In certain embodiments, a cross-section of the first through-hole may have a stepped shape, and/or a cross-section of the second through-hole may have a stepped shape. Referring to FIG. 7, the cross-sections of the first through-hole 26 and the second through-hole 27 may have a stepped shape. The light signal indicated by 41 of the light signal emitted by the light-emitting component 21 may pass through the first through-hole 26 and the first optical element 23. Similarly, for the second optical element 24, the light signal indicated by 42 of the light signal reflected by the target object may pass through the second through-hole 27 to reach the photosensitive component 22.

In addition, the cross-section of the first through-hole 26 may not be limited to a stepped shape, and may have any other suitable shape, as long as the diameter of the first through-hole 26 gradually decreases along the direction approaching the light-emitting component 21. Similarly, the cross-section of the second through-hole 27 may not be limited to a stepped shape, and may have any other suitable shape, as long as the diameter of the second through-hole 27 gradually decreases along the direction approaching the photosensitive component 22.

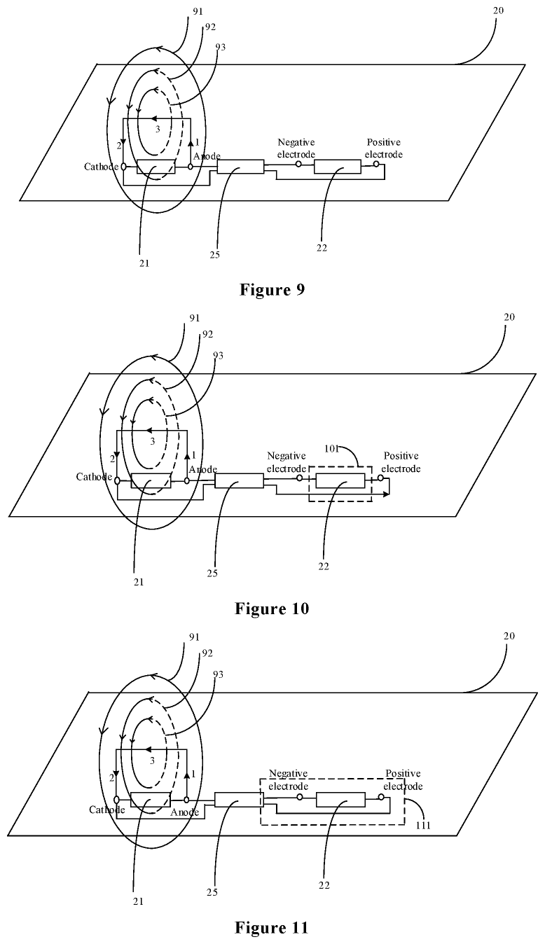

In certain embodiments, a cross-section of the first through-hole may have a tapered shape, and/or a cross-section of the second through-hole may have a tapered shape. Referring to FIG. 8, the cross-sections of the first through-hole 26 and the second through-hole 27 may have a tapered shape. The light signal indicated by 41 among the light signal emitted by the light-emitting component 21 may pass through the first through-hole 26 and the first optical element 23. Similarly, for the second optical element 24, the light signal indicated by 42 of the light signal reflected by the target object may pass through the second through-hole 27 to reach the photosensitive component 22.

In the disclosed embodiments, the diameter of the first through-hole may gradually decrease along the direction approaching the light-emitting component, and/or the diameter of the second through-hole may gradually decrease along the direction approaching the photosensitive component. Therefore, a substantially large amount of light signal emitted by the light-emitting component may pass through the first through-hole and the first optical element, and/or a substantially large amount of light signal reflected by the target object may pass through the second through-hole to reach the photosensitive component. The light utilization may be improved, and the detecting performance of the detecting equipment may be improved.

The present disclosure provides a detecting equipment. FIG. 9 illustrates a schematic structural diagram of a detecting equipment consistent with disclosed embodiments of the present disclosure. Referring to FIG. 9, when emitting a light signal, the light-emitting component 21 may desire to be turned on. In other words, a current may desire to flow from an anode of the light-emitting component 21 to a cathode of the light-emitting component 21. In one embodiment, the anode of the light-emitting component 21 and the cathode of the light-emitting component 21 may be electrically connected to the processing component 25, respectively, to form a circuit.

Referring to FIG. 9, the current flowing from the anode of the light-emitting component 21 to the cathode of the light-emitting component 21 may include three parts, and may be labeled as a partial current 1, a partial current 2 and a partial current 3, respectively. The partial current 1 may have a current direction opposite to the partial current 2. Therefore, the induced magnetic field generated by the partial current 1 and the induced magnetic field generated by the partial current 2 may cancel each other. However, the induced magnetic field generated by the partial current 3 may not be canceled. According to the principle of electromagnetic induction, the induced magnetic field generated by the partial current 3 may be perpendicular to the plane of the circuit board 20, e.g., a PCB board, as illustrated in FIG. 9, where 91, 92, and 93 may represent magnetic induction lines, respectively.

Similarly, a positive electrode and a negative electrode of the photosensitive component 22 may be electrically connected to the processing component 25 to form a circuit. The photosensitive component 22 may often convert the received light signal into an electrical signal, e.g., a current, and the strength of the light signal received by the photosensitive component 22 may be characterized by a magnitude of the electrical signal, e.g., a current. However, a value of the current generated by the light signal received by the photosensitive component 22 may often be substantially small, in a range of approximately nA. Therefore, the current signal corresponding to the light signal received by the photosensitive component 22 may be easily susceptible to electromagnetic noise interference.

However, in the current flowing from the anode of the light-emitting component 21 to the cathode of the light-emitting component 21, the induced magnetic field generated by the partial current 3 may generate an induced current on the circuit of the photosensitive component 22, thereby causing electromagnetic noise generated by the light-emitting component 21 to interfere the photosensitive component 22. To solve such issues, on the basis of the above-disclosed embodiments, the detecting equipment may further include a first shielding component. The first shielding component may be configured to reduce the interference of the electromagnetic noise to the photosensitive component.

In one embodiment, the first shielding component may be configured to reduce interference of the electromagnetic noise generated by the light-emitting component to the photosensitive component.

In one embodiment, the first shielding component may include a metal shielding cover. The first shielding component may at least partially cover the photosensitive component, or may at least partially cover a wiring loop between the photosensitive component and the processing component. In one embodiment, the first shielding component may be disposed on the first plane of the circuit board.

Referring to FIG. 10, the detecting equipment may further include a first shielding component 101. The first shielding component 101 may be configured to reduce the interference of the electromagnetic noise to the photosensitive component 22. In one embodiment, the first shielding component 101 may be configured to reduce the interference of the electromagnetic noise generated by the light-emitting component 21 to the photosensitive component 22. The first shielding component 101 may cover the periphery of the photosensitive component 22. In one embodiment, the first shielding component 101 may be ground.

In one embodiment, the first shielding component 101 may include a metal shielding cover, and the metal shielding cover may be ground. In addition, the first shielding component 101 may be disposed on the first plane of the circuit board 20. In other words, the first shielding component 101 and the photosensitive component 22 may be disposed on a same plane of the circuit board 20.

Referring to FIG. 11, the detecting equipment may further include a first shielding component 111. The first shielding component 111 may not only cover the photosensitive component 22, but also cover a wiring loop between the photosensitive component 22 and the processing component 25. In one embodiment, the first shielding component 111 may be ground.

In one embodiment, the first shielding component 111 may include a metal shielding cover, and the metal shielding cover may be ground. In addition, the first shielding component 111 may be disposed on the first plane of the circuit board 20. In other words, the first shielding component 111 and the photosensitive component 22 may be disposed on a same plane of the circuit board 20.

In addition, on the basis of the above-disclosed embodiments, the detecting equipment may further include a second shielding component. The second shielding component may at least partially cover the light-emitting component, or may at least partially cover the wiring loop between the light-emitting component and the processing component. In one embodiment, the second shielding component may include a metal shielding cover. In one embodiment, the second shielding component may be disposed on the first plane of the circuit board.

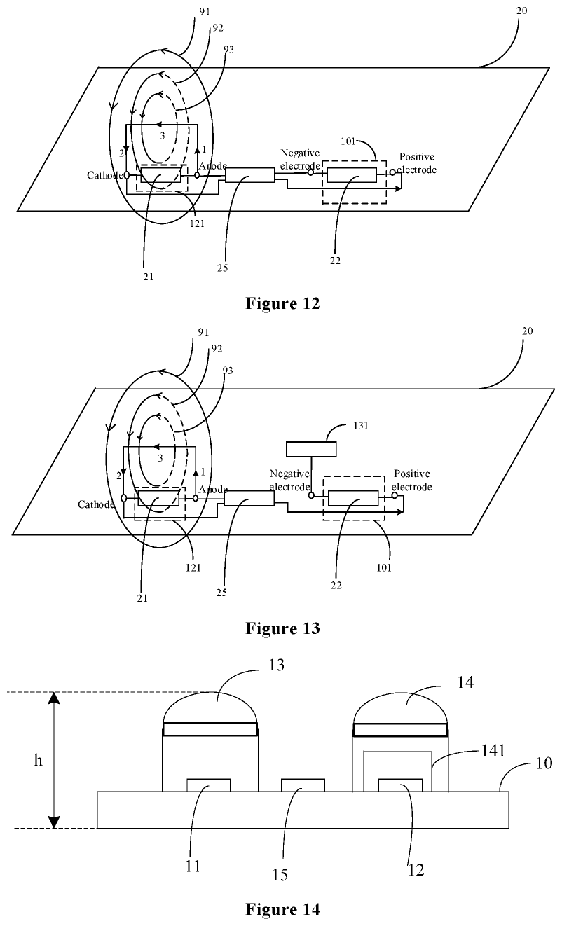

On the basis of FIGS. 9-11, the detecting equipment may further include a second shielding component. Referring to FIG. 12, on the basis of FIG. 10, the detecting equipment may further include a second shielding component 121. The second shielding component 121 may cover the periphery of the light-emitting component 21. In one embodiment, the second shielding component 121 may be ground.

In one embodiment, the second shielding component 121 may include a metal shielding cover, and the metal shielding cover may be ground. In addition, the second shielding component 121 may be disposed on the first plane of the circuit board 20. In other words, the second shielding component 121 and the light-emitting component 21 may be disposed on the same plane of the circuit board 20. In certain embodiments, the second shielding component 121 may not only cover the light-emitting component 21, but also cover the wiring loop between the light-emitting component 21 and the processing component 25.

In the disclosed embodiments, the detecting equipment may contain the first shielding component and/or the second shielding component. Therefore, the interference of the electromagnetic noise generated by the light-emitting component to the photosensitive component may be reduced, the signal-to-noise ratio of the electrical signal generated by the photosensitive component may be effectively improved, and the detecting performance of the detecting equipment may be improved.

The present disclosure provides a detecting equipment. FIG. 13 illustrates a schematic structural diagram of another detecting equipment consistent with disclosed embodiments of the present disclosure. Based on the above-disclosed embodiments, referring to FIGS. 9-12, the positive electrode and the negative electrode of the photosensitive component 22 may be electrically connected to the processing component 25, respectively. The photosensitive component 22 may be a photodiode, and the photodiode may operate under a reverse voltage. The processing component 25 may provide a high voltage to the negative electrode of the photodiode and a low voltage to the positive electrode of the photodiode, such that the photodiode may operate under the reverse voltage.

The processing component 25 may be one or more integrated circuits, and the integrated circuits may be integrated to form a chip. The voltage provided by the chip to external circuit may often be limited to a range, and, thus, the driving capability for the photosensitive component 22 may be insufficient. To solve such issues, in one embodiment, the detecting equipment may further include a biasing circuit. The biasing circuit may be configured to provide a biasing voltage to the photosensitive component. The negative electrode of the photosensitive component may be electrically connected to the biasing circuit, and the positive electrode of the photosensitive component may be electrically connected to the processing component.

On the basis of any one of FIGS. 9-12, the detecting equipment may include a biasing circuit. Referring to FIG. 13, on the basis of FIG. 12, the detecting equipment may further include a biasing circuit 131. The biasing circuit 131 may be configured to provide a biasing voltage to the photosensitive component 22. In one embodiment, the negative electrode of the photosensitive component 22 may be electrically connected to the biasing circuit 131, and the positive electrode of the photosensitive component 22 may be electrically connected to the processing component 25. The biasing circuit 131 may provide a substantially large biasing voltage to the photosensitive component 22.

In the disclosed detecting equipment, the biasing circuit may provide a biasing voltage to the photosensitive component, such that the photosensitive component may operate under a substantially large reverse voltage, thereby improving the light-receiving performance of the photosensitive component.

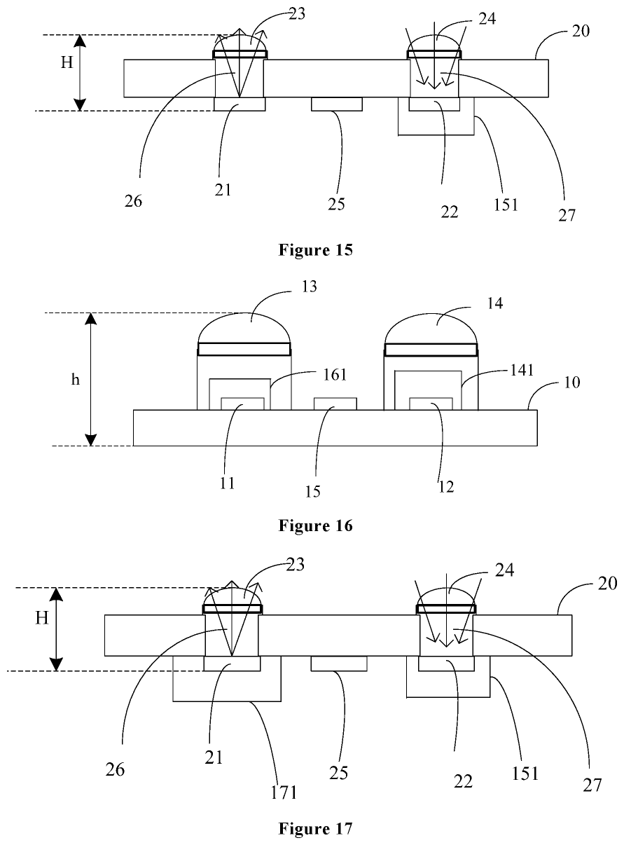

The present disclosure provides a detecting equipment. FIG. 14 illustrates a schematic structural diagram of another detecting equipment consistent with disclosed embodiments of the present disclosure. In one embodiment, the detecting equipment may include a light-emitting component, a photosensitive component, a processing component, a first optical element, a second optical element, a circuit board, and a first shielding component. The light-emitting component, the photosensitive component, and the processing component may be disposed on the circuit board. The light-emitting component and the photosensitive component may be electrically connected to the processing component, respectively. The light-emitting component may be configured to emit a light signal, and the photosensitive component may be configured to receive a light signal reflected by a target object. The processing component may be configured to according to the light signal emitted by the light-emitting component and the light signal received by the photosensitive component and reflected by the target object, determine information associated with the target object. The first shielding component may at least partially cover the photosensitive component or may at least partially cover the wiring loop between the photosensitive component and the processing component, and may be configured to reduce the interference of electromagnetic noise to the photosensitive component.

Referring to FIG. 14, in one embodiment, the detecting equipment may be a TOF detecting equipment. The TOF detecting equipment may include a circuit board 10, a light-emitting component 11, a photosensitive component 12, an optical element 13, an optical element 14, a processing component 15, and a first shielding component 141. The light-emitting component 11, the photosensitive component 12, and the processing component 15 may be disposed on the circuit board 10. The light-emitting component 11 and the photosensitive component 12 may be electrically connected to the processing component 15, respectively. The light-emitting component 11 may be configured to emit a light signal, and the photosensitive component 12 may be configured to receive a light signal reflected by a target object. The processing component 15 may be configured to according to the light signal emitted by the light-emitting component 11 and the light signal received by the photosensitive component 12 and reflected by the target object, determine information associated with the target object. The first shielding component 141 may cover the periphery of the photosensitive component 12. In another embodiment, the first shielding component 141 may simultaneously cover the photosensitive component 12 and the wiring loop between the photosensitive component 12 and the processing component 15, to reduce the interference of electromagnetic noise to the photosensitive component 12.

In one embodiment, the first shielding component may be configured to reduce the interference of the electromagnetic noise generated by the light-emitting component to the photosensitive component. In other words, the first shielding component 141 may be configured to reduce the interference of the electromagnetic noise generated by the light-emitting component 11 to the photosensitive component 12. In one embodiment, the first shielding component 141 may be ground. The first shielding component 141 may include a metal shielding cover, and the metal shielding cover may be ground.

Referring to FIG. 15, the detecting equipment may include a circuit board 20, a light-emitting component 21, a photosensitive component 22, a first optical element 23, a second optical element 24, a processing component 25, and a first shielding component 151. The light-emitting component 21, the photosensitive component 22 and the processing component 25 may be disposed on the circuit board 20. The light-emitting component 21 and the photosensitive component 22 may be electrically connected to the processing component 25, respectively. The light-emitting component 21 may be configured to emit a light signal, and the photosensitive component 22 may be configured to receive a light signal reflected by the target object. The processing component 25 may be configured to determine information associated with the target object according to the light signal emitted by the light-emitting component 21 and the light signal received by the photosensitive component 22 and reflected by the target object. The first shielding component 151 may cover the periphery of the photosensitive component 22. In another embodiment, the first shielding component 151 may simultaneously cover the photosensitive component 22 and the wiring loop between the photosensitive component 22 and the processing component 25, to reduce the interference of electromagnetic noise to the photosensitive component 22.

In one embodiment, the first shielding component may be configured to reduce interference of the electromagnetic noise generated by the light-emitting component to the photosensitive component. In other words, the first shielding component 151 may be configured to reduce the interference of the electromagnetic noise generated by the light-emitting component 21 on the photosensitive component 22. In one embodiment, the first shielding component 151 may be ground. The first shielding component 151 may include a metal shielding cover, and the metal shielding cover may be ground.

In addition, the detecting equipment may further include a second shielding component. The second shielding component may at least partially cover the light-emitting component, or may at least partially cover a wiring loop between the light-emitting component and the processing component.

Referring to FIG. 16, on the basis of Figure14, the detecting equipment may further include a second shielding component 161. The second shielding component 161 may cover the periphery of the light-emitting component 11. In another embodiment, the second shielding component 161 may simultaneously cover the light-emitting component 11 and the wiring loop between the light-emitting component 11 and the processing component 15, to reduce the interference of the electromagnetic noise to the photosensitive component. In one embodiment, the interference of the electromagnetic noise generated by the light-emitting component 11 on the photosensitive component 12 may be reduced. In one embodiment, the second shielding component 161 may be ground. The second shielding component 161 may include a metal shielding cover, and the metal shielding cover may be ground.

Referring to FIG. 17, on the basis of FIG. 15, the detecting equipment may further include a second shielding component 171. The second shielding component 171 may cover the periphery of the light-emitting component 21. In another embodiment, the second shielding component 171 may simultaneously cover the light-emitting component 21 and the wiring loop between the light-emitting component 21 and the processing component 25, to reduce the interference of the electromagnetic noise to the photosensitive component. In one embodiment, the interference of the electromagnetic noise generated by the light-emitting component 21 on the photosensitive component 22 may be reduced. In one embodiment, the second shielding component 171 may be ground. The second shielding component 171 may include a metal shielding cover, and the metal shielding cover may be ground.

In one embodiment, the light-emitting component and the photosensitive component may be disposed on the first plane of the circuit board, and the first optical element and the second optical element may be disposed on the second plane of the circuit board. The circuit board may contain a first through-hole and a second through-hole. The light signal emitted by the light-emitting component may successively pass through the first through-hole and the first optical element, and the light signal reflected by the target object may successively pass through the second optical element and the second through-hole to reach the photosensitive component.

Referring to FIG. 15 or FIG. 17, the light-emitting component 21 and the photosensitive component 22 may be disposed on the first plane of the circuit board 20. The first optical element 23 and the second optical element 24 may be disposed on the second plane of the circuit board 20. The circuit board 20 may contain a first through-hole 26 and a second through-hole 27. The light signal emitted by the light-emitting component 21 may successively pass through the first through-hole 26 and the first optical element 23. The light signal reflected by the target object may successively pass through the second optical element 24 and the second through-hole 27 to reach the photosensitive component 22.

In one embodiment, the light-emitting component and the photosensitive component may be attached to the first plane of the circuit board, and the first optical element and the second optical element may be attached to the second plane of the circuit board.

Referring to FIG. 15 or FIG. 17, in one embodiment, the light-emitting component 21 and the photosensitive component 22 may be attached to the first plane of the circuit board 20. The first optical element 23 and the second optical element 24 may be attached to the second plane of the circuit board 20. The processing component 25 may be attached to the first plane of the circuit board 20. In one embodiment, the circuit board 20 may be a PCB. The light-emitting component 21, the photosensitive component 22, and the processing component 25 may be attached to the back of the PCB.

In one embodiment, an optical axis of the light-emitting component, an axis of the first through-hole, and an optical axis of the first optical element may substantially overlap with each other. In one embodiment, an optical axis of the second optical element and an axis of the second through-hole may substantially overlap with each other.

Referring to FIG. 15 or FIG. 17, the optical axis of the light-emitting component 21, the axis of the first through-hole 26, and the optical axis of the first optical element 23 may substantially overlap with each other. The optical axis of the second optical element 24 and the axis of the second through-hole 27 may substantially overlap with each other.

In one embodiment, the diameter of the first through-hole may gradually decrease along a direction approaching the light-emitting component, and/or the diameter of the second through-hole may gradually decrease along a direction approaching the photosensitive component. The details may refer to descriptions associated with FIG. 7 or FIG. 8, where are not described herein.

In the disclosed embodiments, the detecting equipment may include the first shielding component. Therefore, the interference of the electromagnetic noise generated by the light-emitting component to the photosensitive component may be reduced, the signal-to-noise ratio of the electrical signal generated by the photosensitive component may be effectively improved, and the detecting performance of the detecting equipment may be improved.

The present disclosure provides a movable platform. The movable platform may include a fuselage, a power system, and a detecting equipment in the above-disclosed embodiments. The power system may be installed on the fuselage, and may be configured to provide power. The detailed implementation manner and structure of the detecting equipment may be consistent with the above-disclosed embodiments, and may not be repeated herein. In one embodiment, the movable platform may include an unmanned aerial vehicle.

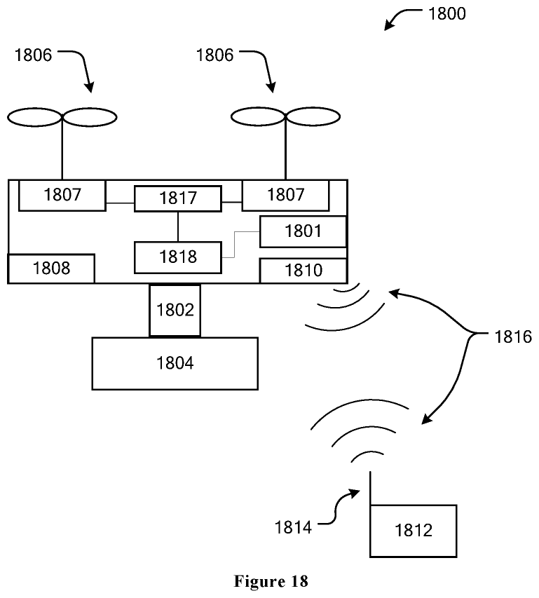

The present disclosure provides an unmanned aerial vehicle. FIG. 18 illustrates a schematic structural diagram of an unmanned aerial vehicle consistent with disclosed embodiments of the present disclosure. Referring to FIG. 18, the unmanned aerial vehicle 1800 may include a fuselage, a power system, a flight controller 1818, and a detecting equipment 1801. The power system may include at least one of a motor 1807, a propeller 1806, or an electronic governor 1817. The power system may be installed on the fuselage to provide flight power. The flight controller 1818 may be communicatively connected to the power system, and may be configured to control the flight of the unmanned aerial vehicle. The detailed implementation manner and structure of the detecting equipment 1801 may be consistent with detecting equipment in the above-disclosed embodiments, and may not be repeated herein.

In addition, referring to FIG. 18, the unmanned aerial vehicle 1800 may further include a sensing system 1808, a communicating system 1810, a supporting device 1802, and a photographing device 1804. The supporting device 1802 may be a gimbal. The communicating system 1810 may include a receiver, and the receiver may be configured to receive a wireless signal sent by an antenna 1814 of the receiving ground station 1812. Electromagnetic wave 1816 may be generated during the communication between the receiver and the antenna 1814.

In the disclosed detecting equipment and movable platform, the light-emitting component and the photosensitive component may be disposed on the first plane of the circuit board. The first optical element corresponding to the light-emitting component and the second optical element corresponding to the photosensitive component may be disposed on the second plane of the circuit board. The first through-hole and the second through-hole may be disposed on the circuit board. Therefore, the light signal emitted by the light-emitting component may successively pass through the first through-hole and the first optical element to emit, and the light signal reflected by the target object may successively pass through the second optical element and the second through-hole to reach the photosensitive component. When the first optical element has a size consistent with the second optical element, the thickness of the detecting equipment may be the distance between the first optical element and the light-emitting component. The distance between the first optical element and the light-emitting component may already include the thickness of the circuit board itself, which may fully utilize the thickness of the circuit board itself to reduce the thickness of the detecting equipment, thereby saving the installation space of the detecting equipment on the movable platform.

In the disclosed embodiments of the present disclosure, the disclosed equipment and method may be achieved in any other suitable manner. For example, the above-described device embodiments are merely schematic. For example, the division of the unit may be merely a logical function division, and may have any other suitable division manner in actual implementation. For example, a plurality of units or components may be combined or may be integrated into another system. Alternatively, some features may be ignored or may not be performed. In addition, the illustrated or discussed coupling or direct coupling or communication connection may be achieved through some interfaces, and indirect coupling or communication connection between devices or units may be electrical, mechanical or any other suitable form.

The units described as separate components may or may not be physically separated. The components displayed as units may or may not be physical units, i.e., may be located in a same place, or may be distributed on a plurality of network units. Some or entire units may be selected according to practical applications to achieve the purpose of scheme of the disclosed embodiments.

In addition, each functional unit in each embodiment of the present disclosure may be integrated into one processing unit. Alternatively, each unit may be separately physically provided. Alternatively, two or more units may be integrated into one unit. The above integrated unit may be achieved in the form of hardware, or may be achieved in the form of hardware and software functional unit.

The above integrated unit achieved in the form of a software functional unit may be stored in a computer-readable storage medium. The above software functional unit may be stored in a storage medium, and may include a plurality of instructions for enabling a computer device (e.g., a personal computer, a server, or a network device) or a processor to execute the methods described in the disclosed embodiments of the present disclosure. The foregoing storage medium may include a U disk, a mobile hard disk, a read-only memory (ROM), a random access memory (RAM), a magnetic disk, a compact disc, or any other medium capable of storing program codes.

Those skilled in the art can clearly understand that for the convenience and brevity of the description, the above-mentioned division of the functional components may be used as an example. In practical applications, the above-mentioned functions may be achieved by allocating to different functional components according to practical applications. The internal structure of the equipment may be divided into different functional components to achieve entire or part of the functions described above. The detailed operating process of the above-described equipment may refer to the corresponding process in the foregoing method embodiments, which are not repeated herein.

The above detailed descriptions only illustrate certain exemplary embodiments of the present disclosure, and are not intended to limit the scope of the present disclosure. Those skilled in the art can understand the specification as whole and technical features in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A detecting equipment, comprising:
a light-emitting component, a photosensitive component, a processing component, a first optical element, a second optical element, and a circuit board, wherein:
the light-emitting component, the photosensitive component, and the processing component are configured on the circuit board, and the light-emitting component and the photosensitive component are electrically connected to the processing component, respectively,
the light-emitting component and the photosensitive component are configured on a first plane of the circuit board, and the first optical element and the second optical element are configured on a second plane of the circuit board,
the circuit board contains a first through-hole and a second through-hole, a light signal emitted by the light-emitting component is configured to successively pass through the first through-hole and the first optical element, and a light signal reflected by a target object is configured to successively pass through the second optical element and the second through-hole to reach the photosensitive component, and
according to the light signal emitted by the light-emitting component and the light signal received by the photosensitive component and reflected by the target object, the processing component is configured to determine information associated with the target object.

2. The detecting equipment according to claim 1, wherein:
the processing component is configured to determine the information associated with the target object according to a time when the light-emitting component emits the light signal and a time when the photosensitive component receives the light signal reflected by the target object.

3. The detecting equipment according to claim 1, wherein:
the processing component is configured to determine the information associated with the target object according to a phase of the light signal emitted by the light-emitting component and a phase of the light signal received by the photosensitive component and reflected by the target object.

4. The detecting equipment according to claim 1, wherein:
the information associated with the target object is determined based on determination of at least one of a distance between the target object and the detecting equipment, position information of the target object with respect to the detecting equipment, or speed information of the target object with respect to the detecting equipment.

5. The detecting equipment according to claim 1, wherein:
the light-emitting component and the photosensitive component are attached to the first plane of the circuit board.

6. The detecting equipment according to claim 1, wherein:
the first optical element and the second optical element are attached to the second plane of the circuit board.

7. The detecting equipment according to claim 1, wherein:
an optical axis of the light-emitting component, an axis of the first through-hole, and an optical axis of the first optical element substantially overlap with each other.

8. The detecting equipment according to claim 1, wherein:
an optical axis of the second optical element and an axis of the second through-hole substantially overlap with each other.

9. The detecting equipment according to claim 1, wherein:
a diameter of the first through-hole gradually decreases along a direction approaching the light-emitting component, and/or
a diameter of the second through-hole gradually decreases along a direction approaching the photosensitive component.

10. The detecting equipment according to claim 1, wherein:
one or more of the first through-hole and the second through-hole are a cylindrical through-hole or a rounded rectangular through-hole.

11. The detecting equipment according to claim 1, wherein:
the processing component is attached to the first plane of the circuit board.

12. The detecting equipment according to claim 1, further including:
a first shielding component, configured to reduce an interference of an electromagnetic noise to the photosensitive component.

13. The detecting equipment according to claim 12, wherein:
the first shielding component is configured to reduce the interference of the electromagnetic noise generated by the light-emitting component to the photosensitive component.

14. The detecting equipment according to claim 12, wherein:
the first shielding component includes a metal shielding cover.

15. The detecting equipment according to claim 12, wherein:
the first shielding component at least partially covers the photosensitive component, or
the first shielding component at least partially covers a wiring loop between the photosensitive component and the processing component.

16. The detecting equipment according to claim 12, wherein:
the first shielding component is configured on the first plane of the circuit board.

17. The detecting equipment according to claim 12, further including:
a second shielding component, wherein:
the second shielding component at least partially covers the light-emitting component, or
the second shielding component at least partially covers a wiring loop between the light-emitting component and the processing component.

18. The detecting equipment according to claim 17, wherein:
the second shielding component includes a metal shielding cover.

19. The detecting equipment according to claim 17, wherein:
the second shielding component is configured on the first plane of the circuit board.

20. The detecting equipment according to claim 1, further including:
a biasing circuit, wherein:
the biasing circuit is configured to provide a biasing voltage to the photosensitive component,
a negative electrode of the photosensitive component is electrically connected to the biasing circuit, and
a positive electrode of the photosensitive component is electrically connected to the processing component.
